(19) United States
(12) Patent Application Publication
(10) Pub. No.: US 2010/0012609 A1
(43) Pub. Date: Jan. 21, 2010

(54) Adaptable hoist fixture

(76) Inventors: Jonathan Edward Morgan, Los Alamos, NM (US); Garth E. Reader, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 12/218,722

(22) Filed: Jul. 16, 2008

(51) Int. Cl. B66C 21/04

(52) U.S. Cl. 212/110; 212/120

(57) ABSTRACT

Apparatus for securing hoist rigging comprising a first and a second polyhedral frame, and support members having two ends, wherein one end is attached to a corner of the first polyhedral frame and the second end is attached to a corner of the second polyhedral frame, so as to position the frames in a substantially parallel and superposed position.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD OF THE INVENTION

The present invention relates to an apparatus for stably securing a means for hoisting a variety of objects, in particular, irregularly shaped or difficult to stabilize objects, and further to an adaptable hoist comprising the apparatus.

### BACKGROUND OF THE INVENTION

Lifting large and/or heavy objects typically requires a means for securing the objects to a hoist, crane, or similar apparatus. This may be accomplished, for example, by fashioning one or more ropes, chains or straps around the object. With some objects, for example regularly-shaped objects such as large pipes, it is possible to simply place a single strap around the object, whereupon the object will be sufficiently balanced and stable to be lifted. With irregularly-shaped objects (for example, custom parts or machinery, large boulders or other such objects), or regularly-shaped objects that are difficult to secure (for example, spherical objects), this may not be possible. In such cases a custom rigging and hoist apparatus must be built, which may only be used for one particular object, and thus is expensive and time-consuming to construct. Furthermore, if the object is heavy, it becomes difficult to secure a strap or rope underneath the object.

A need exists, therefore, for a means to lift unusually-shaped objects, round objects, and other objects that would require specialized lifting fixtures that are application specific (e.g., one-time use only), expensive, and require labor-intensive design, engineering and fabrication.

### SUMMARY OF THE INVENTION

The present invention meets the aforementioned need by providing an adaptable, and thus essentially universal, means for securing hoist rigging. The apparatus can be used to stably hoist a wide variety of objects, including irregularly-shaped and round objects, and thus eliminates the need for a costly custom-built hoisting apparatus.

The following describe some non-limiting embodiments of the present invention.

According to a first embodiment of the present invention, an apparatus for securing hoist rigging is provided, comprising a first and a second polyhedral frame, and support members having two ends, wherein one end is attached to a corner of the first polyhedral frame and the second end is attached to a corner of the second polyhedral frame, so as to position the frames in a substantially parallel and superposed position.

According to a second embodiment of the present invention, an adaptable hoist for stably securing objects is provided, comprising a first and a second polyhedral frame, wherein said polyhedral frame has an even number of sides; support members having two ends, wherein one end is attached to a corner of the first polyhedral frame and the second end is attached to a corner of the second polyhedral frame, so as to position the frames in a substantially parallel and superposed position; a plurality of bars, the ends of said bars slideably connected to adjacent support members, such that alternating sides of the polyhedral frame comprise a bar; and a plurality of hoisting means, each of which has at least one portion adjustably immobilized by a bar.

### BRIEF DESCRIPTION OF THE DRAWINGS

FIG. 1 depicts one embodiment of an apparatus for stably securing hoist rigging of the present invention.

FIG. 2 depicts an enlarged view of the apparatus of FIG. 1, showing one manner of securing the hoist rigging.

FIG. 3 depicts one embodiment of a hoisting apparatus of the present invention.

FIG. 4 depicts an alignment plate, as viewed from the top.

FIG. 5 depicts one side of a polyhedral frame, as viewed from the side (FIG. 5a ) and from the top (FIG. 5b ).

FIG. 6 depicts an apparatus for stably securing for example a round object having a hoisting apparatus comprising an upper and a lower triangular polyhedral frame.

### DETAILED DESCRIPTION OF THE INVENTION

The present invention relates to an apparatus for stably securing a means for hoisting a heavy, irregularly shaped and/or difficult to stabilize objects, such as round and/or smooth objects. The means for hoisting may be hoist rigging such as straps, chains, ropes, cables and the like. The invention further relates to an adaptable hoist comprising the apparatus, which is adjustable, non-application specific, and thus suitable for multiple uses.

“Superposed,” as used herein, means that the first frame is placed above or below the second frame such that all like parts coincide when viewed from the top.

“Adjustably immobilized,” as used herein in reference to a hoisting means, means that the hoisting means remains substantially immobilized when pressure is exerted in the form of pulling, yet which can be loosened and adjusted (e.g., slid to a new position to create a longer or shorter hoisting means) in the absence of pressure on the hoisting means.

“Securely fastened,” as used herein in reference to a hoisting means, means that whether in the absence or presence of pressure (e.g., pulling), the hoisting means remains in substantially the same position relative to that to which it is fastened.

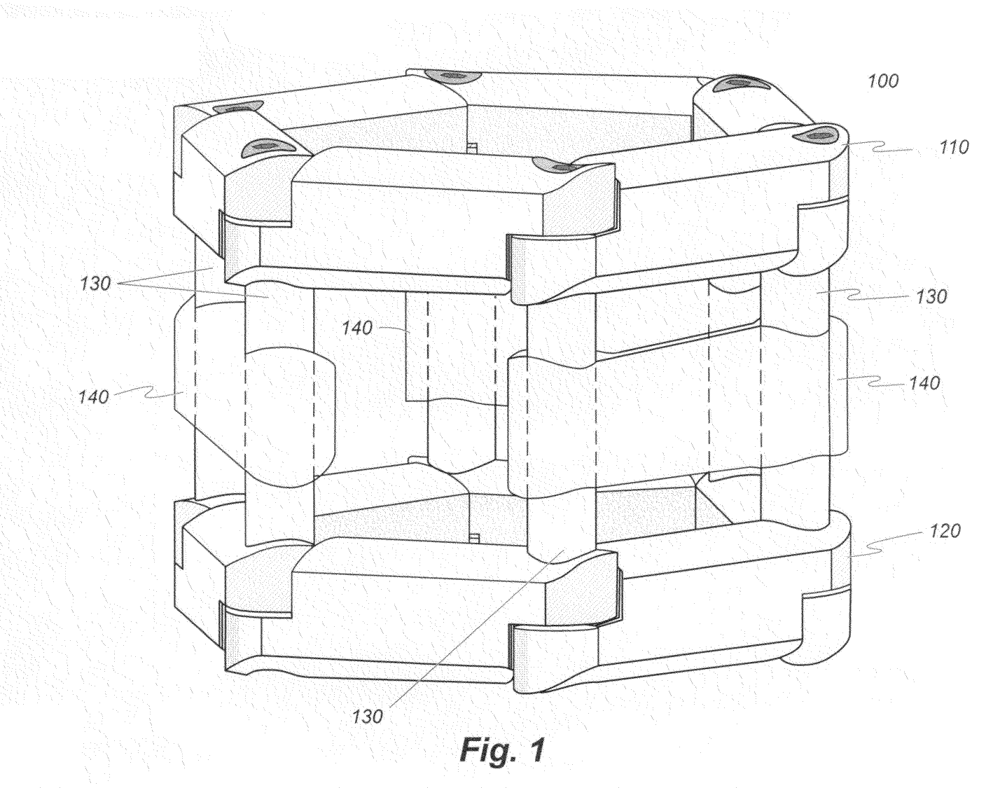

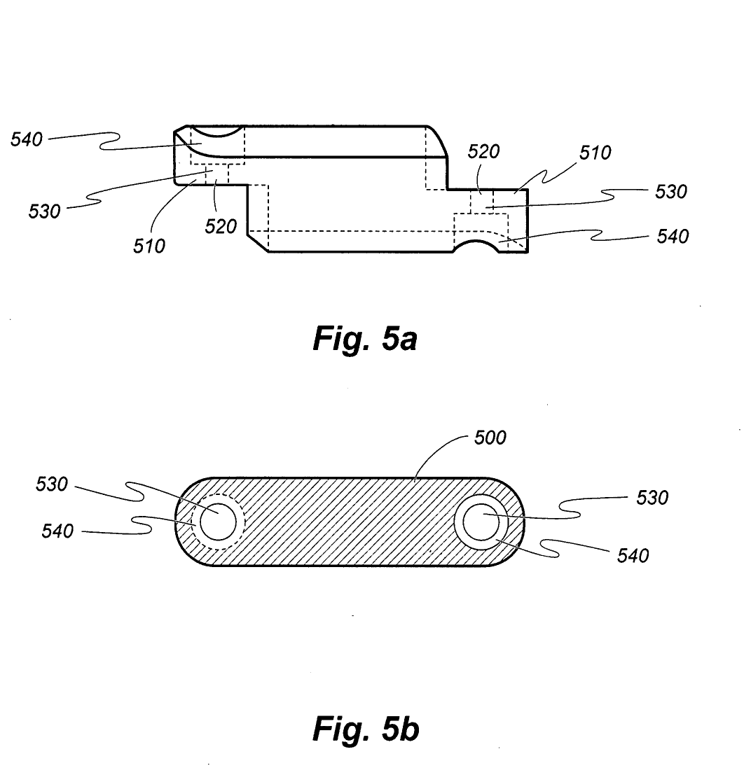

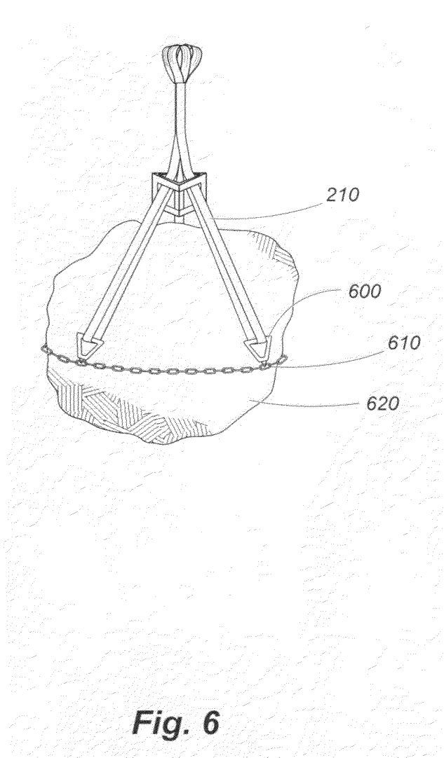

FIG. 1 depicts one embodiment of the apparatus for stably securing hoist rigging, or “apparatus,” 100. The apparatus 100 comprises a first, or upper, polyhedral frame 110 and a second, or lower, polyhedral frame 120. Whereas it would be possible to utilize more than two polyhedral frames, at least two frames are required for the purposes of the present invention. The polyhedral frames 110 and 120 may be a variety of shapes, including a triangle, a square, a pentagon, a hexagon, an octagon, a decagon, etc. Although the polyhedral frames 110 and 120 may comprise any number of side members, or sides, 500 (as shown in FIG. 5), an even number of sides may be preferable when each means for hoisting extends from the apparatus, around the object, and back up through the apparatus, in which case an even number of sides ensures that no side is devoid of a hoisting means and thus greater balance is achieved. However, when the object is a round or oblong object, a triangular polyhedron may be more useful for securing hoisting rigging, as depicted in FIG. 6. In one embodiment, the polyhedral frame comprises ten or fewer sides, and preferably is a hexagon, octagon or a decagon, and more preferably is a hexagon.

Non-polyhedral, for example circular or ovoid, frames also may be employed. However, non-polyhedral frames are believed to provide less stability, as the hoisting means may shift position. Furthermore, non-polyhedral frames are not conducive to providing a means to adjustably immobilize straps or other hoisting means, for example as provided by bars 140 (discussed in more detail below).

The upper and lower polyhedral frames 110 and 120 are attached to each other by means of support members 130, the number of which corresponds to the number of sides of the polyhedron. The support members are attached to the frames such that one end is attached to a corner of the first polyhedral frame and the second end is attached to a corner of the second polyhedral frame, so as to position the frames in a superposed position as depicted in FIGURE I. The support members are of substantially the same length, so as to ensure that the frames are substantially parallel, which facilitates optimal balance for the object.

In one embodiment, bars 140 are positioned between the support members, such that each end of a bar is slideably attached to an adjacent support member. In other words, each bar may slide freely up and down along the support members. In one embodiment, the number of bars is equal to or less than the number of sides of the polyhedron. In another embodiment, the number of bars is half the number of sides of a polyhedron having an even number of sides, and are arranged such that a bar is positioned between alternating sides of the upper and lower polyhedral frames 110 and 120 (as depicted in FIG. 1).

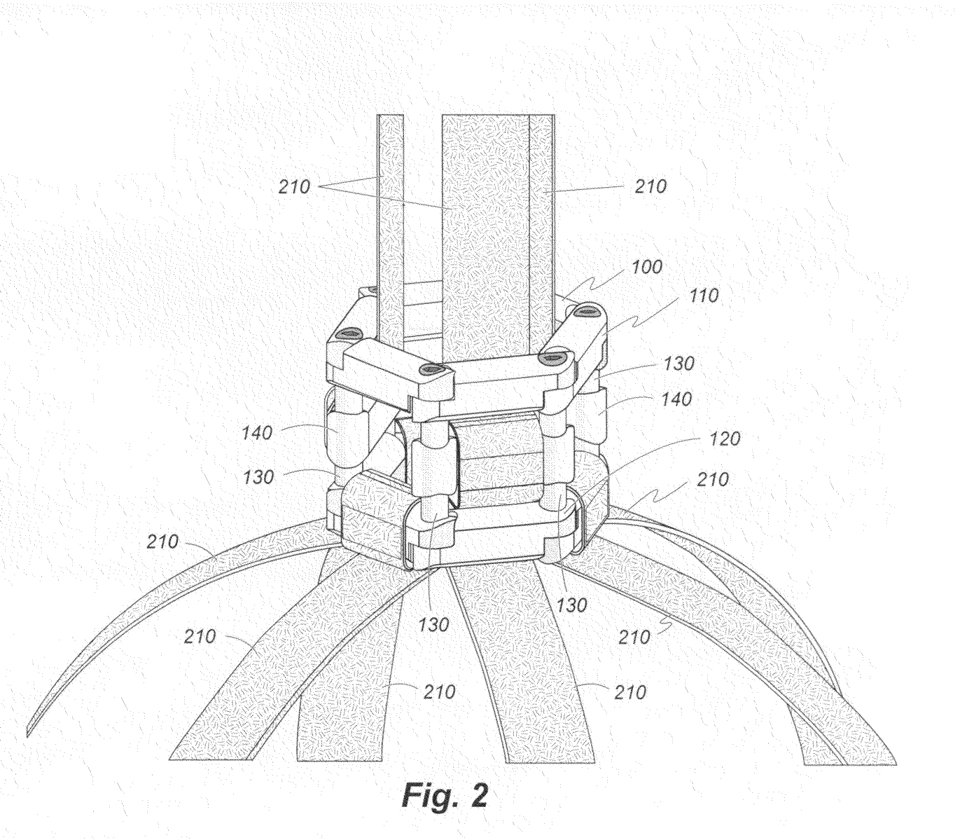

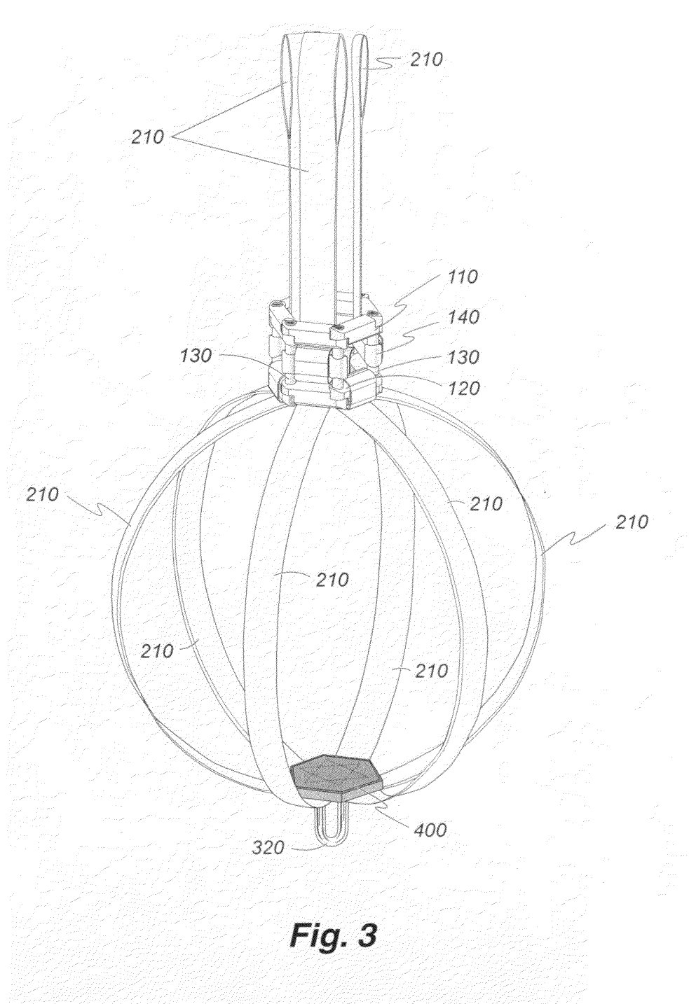

FIG. 2 depicts one manner of securing means for hoisting, or hoist rigging, 210. The hoist rigging shown in FIG. 2 is a preferred embodiment comprising straps; however, suitable types of rigging include but are not limited to straps, chains, cables, ropes, and combinations thereof. Each hoist rigging may comprise a means for attaching to a lifting means, such as an eye or a loop on one end, suitable for attachment to a lifting means such as a hook, ring, crane, or other holder. When the apparatus comprises one or more bars, the hoist rigging may pass through the inside of the frame, and around the outside of the bar and back through the inside of the frame, such that the hoisting means is adjustably immobilized by the bar in a manner similar to a belt being immobilized by a sliding belt buckle. The hoisting means further extends out of the frame and around the object, as depicted in FIG. 3. After passing around the object, the hoist rigging may return to the apparatus and pass through the inside of the frame. When the apparatus comprises a number of bars equal to half the number of sides of the polyhedron, upon return to the apparatus the hoist rigging preferably passes along a side opposite to the side comprising the bar through which the hoist rigging passed around.

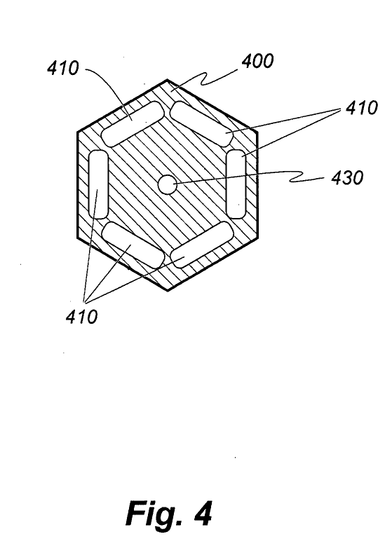

In one embodiment, the second end of each hoisting means is securely fastened to an alignment plate, 400, as shown in FIG. 3. The alignment plate prevents the shifting of the straps with respect to the object, which could result in the object unintentionally slipping free of the hoisting means. In addition, the alignment plate may be used as a lift point to rotate a load. FIG. 4 depicts an alignment plate 400 suitable for use with six or fewer straps. The alignment plate comprises six openings 410, each having a length greater than the width of a strap. The strap may be fastened to the alignment plate by a variety of means that would be known to one of skill in the art. In one embodiment, the strap passes around one side of the object, under the alignment plate 400, through a first opening 410, across the top of the alignment plate 400, and through a second opening 420 opposite the first opening, and around another side of the object. The alignment plate may have an opening 430, such as a tapped opening, for attaching a screw, hook, U-ring (shown in FIG. 3), or other stabilizer 320.

FIGS. 5a and 5b depict respectively side and top views of one side member 500 of upper and lower polyhedral frames 110 and 120. The notched ends 510 comprise an opening 510 having a narrow portion 530 and a wider portion 540. The notched ends may be of a sufficient height to allow notched ends of adjoining side members to align with each other in a manner that results in a polyhedral frame having a substantially uniform height. A means of attaching the individual side members to each other (for example, a bolt) may be passed through the opening 510, where a nut having a size to fit within the wider portion 540 may be secured to the bolt.

FIG. 6 depicts one embodiment in which the upper and lower polyhedral frames 110 and 120 are triangular. Hoisting means, such as the straps shown in FIG. 6, pass through the first and the second frames, as previously described herein. The hoisting means may be adjustably immobilized by bars. The hoisting means extends alongside the object 620, through a sling adapter 600, which in turn is attached to a circumferential securing means 610, such as a chain, strap, ring, solid support, etc.

In all embodiments of the present invention, all ranges are inclusive and combinable. The number of significant digits conveys neither a limitation on the indicated amounts nor on the accuracy of the measurements. All numerical amounts are understood to be modified by the word “about” unless otherwise specifically indicated. All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

Whereas particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for securing hoist rigging comprising:
a) a first and a second polyhedral frame; and
b) support members having two ends, wherein one end is attached to a corner of the first polyhedral frame and the second end is attached to a corner of the second polyhedral frame, so as to position the frames in a substantially parallel and superposed position.

2. The apparatus of claim 1, wherein the polyhedral frames each are triangles.

3. The apparatus of claim 1, wherein the polyhedral frames each have an even number of sides.

4. The apparatus of claim 1, wherein the polyhedral frames each are squares, hexagons, octagons or decagons.

5. The apparatus of claim 1 wherein the polyhedral frames each are hexagons.

6. The apparatus of claim 1, further comprising a bar having two ends slideably connected to adjacent support members.

7. The apparatus of claim 1, further comprising a plurality of bars slideably connected to adjacent support members such that each side of the polyhedron comprises a bar.

8. The apparatus of claim 3, further comprising at least two bars, each bar having two ends slideably connected to adjacent support members, such that a bar is positioned between alternating sides of the upper and lower polyhedral frames.

9. The apparatus of claim 1, further comprising a hoisting means adjustably immobilized by the apparatus.

10. The apparatus of claim 9, wherein the hoisting means comprises a strap, a cable, a rope, a chain, or combinations thereof.

11. The apparatus of claim 10, wherein the hoisting means is a strap.

12. The apparatus of claim 8, further comprising a hoisting means adjustably immobilized by each bar.

13. An adaptable hoist for stably securing objects, comprising:
a) a first and a second polyhedral frame, wherein said polyhedral frame has an even number of sides;
b) support members having two ends, wherein one end is attached to a corner of the first polyhedral frame and the second end is attached to a corner of the second polyhedral frame, so as to position the frames in a substantially parallel and superposed position;
c) a plurality of bars, each bar having two ends slideably connected to adjacent support-members, such that a bar is positioned between alternating sides of the upper and lower polyhedral frames; and
d) a plurality of hoisting means, each of which has at least one portion adjustably immobilized by a bar.

14. The hoist of claim 13, wherein the hoisting means is a strap, a cable, a rope or a chain.

15. The hoist of claim 14, wherein the hoisting means is a strap.

16. The hoist of claim 13, wherein a bar is positioned between each of the sides of the first and the second polyhedral frame.

17. The hoist of claim 13, wherein each hoisting means is securely fastened at one end to an alignment plate.

18. The hoist of claim 13, wherein one end of each hoisting means comprises a means of attachment to a stabilizer.

19. The hoist of claim 13, wherein the polyhedral frames each are hexagons, octagons, or decagons.

20. The hoist of claim 13, wherein the polyhedral frames each are hexagons.
